(19) United States
(12) Patent Application Publication
(10) Pub. No.: US 2024/0305712 A1
(43) Pub. Date: Sep. 12, 2024

(54) CONTEXT-DRIVEN PREVENTION OF INADVERTENT INTERRUPTION OF A COMMUNICATION SESSION

(71) Applicant: MOTOROLA MOBILITY LLC, WILMINGTON, DE (US)

(72) Inventors: AMIT KUMAR AGRAWAL, BANGALORE (IN); BHAVANA BHAT, BANGALORE (IN)

(21) Appl. No.: 18/180,416

(22) Filed: Mar. 8, 2023

(51) Int. Cl. H04M 3/42; G10L 15/22; H04M 1/72469

(52) U.S. Cl. CPC H04M 3/42365; G10L 15/22; H04M 1/72469; H04M 3/42221; G10L 15/005

(57) ABSTRACT

A communication device, method, and computer program product mitigate inadvertent user inputs to call controls of a communication device that interrupt outgoing communication during a communication session. The communication device establishes a communication session with second communication device(s). The communication device receives audio input from a microphone and transmits the audio input to the communication session. The communication device receives an input that turns off transmission to the communication session of at least the received audio input. In response to receiving the input that turns off transmission to the communication session of at least the received audio input, determining whether subsequently received audio input contains continuing speech having a high probability of being speech intended to be transmitted to the communication session, the communication device generates a prompt via the output device indicating the input that turns off transmission to the communication session of at least the received audio input.

### BACKGROUND

### 1. Technical Field

The present disclosure relates generally to communication devices that have a user interface device, and in particular to communication devices that have a user interface to present call controls during a communication session.

### 2. Description of the Related Art

User communication devices may be sized for mobility, enabling users to engage in audio as well as video communication sessions in most locations. Within a small handheld form factor, communication devices present sensors and output devices that can be used as a traditional phone handset with a speaker positioned to be used as an earpiece and a microphone positioned to capture audio inputs spoken by a user. Some communication devices such as smartphones have become multi-functional devices, as the designs have increasingly incorporated a large number of capabilities. In an example, rather than being limited to manually actuated control keys and buttons, touch screens are configurable to present visual content and graphical controls in support of many types of applications in addition to user communication sessions. Communication applications take advantage of these capabilities by presenting a user interface with numerous call controls.

As a device that is often carried in hand and brought close to the face, a user may inadvertently select one of the call controls. The user may not be looking at the user interface when the inadvertent selection occurs. Since some of the call controls only affect outgoing communications, such as spoken words or a video image of the user, the user may not detect the interruption of the outgoing communications. Other participants may assume the interruption is intentional and not alert the user. Continued speech by the user intended for the communication session does not reach the other participants.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 depicts a functional block diagram of a communication environment including a communication device having call controls, presented by a user interface that receives user inputs for controlling a communication session with one or more second communication devices, according to one or more embodiments;

FIG. 2 depicts a front view of the communication device presenting a user interface having call controls whose inadvertent selection may interrupt outgoing communication during a communication session, according to one or more embodiments;

FIG. 3 is a flow diagram presenting an example method of mitigating inadvertent user inputs to call controls of a communication device that interrupt outgoing communication during a communication session, according to one or more embodiments;

FIG. 4A-4B (collectively “FIG. 4”) are a flow diagram presenting another example method of mitigating inadvertent user inputs as implemented on a communication device having a touch display, according to one or more embodiments; and

FIGS. 5A-5B (collectively “FIG. 5”) are a flow diagram presenting a method of example implementations of determining that subsequent speech, after an input that interrupts the outgoing communication, has a high probability of being intended for the communication session, according to one or more embodiments.

### DETAILED DESCRIPTION

According to aspects of the present disclosure, a communication device, a method and a computer program product provide for mitigating inadvertent user inputs to call controls of a communication device that interrupt outgoing communication during a communication session. In one or more embodiments, the communication device includes a communications subsystem that enables the communication device to communicatively connect to one or more second communication devices. The communication device includes a microphone and an output device, such as touch display. A controller of the communication device is communicatively connected to the communications subsystem, the microphone, and the output device. The controller establishes, via the communications subsystem, a communication session with the one or more second communication devices. The controller receives audio input from the microphone. The controller transmits, via the communications subsystem, the audio input to the communication session. The controller receives an input, such as touch of a call control presented on the touch display, that turns off transmission to the communication session of at least the received audio input. In response to receiving the input that turns off transmission to the communication session of at least the received audio input, the controller determines whether subsequently received audio input contains continuing speech that has a high probability of being speech intended to be transmitted to the communication session. The controller generates a prompt via the output device indicating activation of the input that turns off transmission to the communication session of at least the received audio input.

In the following detailed description of exemplary embodiments of the disclosure, specific exemplary embodiments in which the various aspects of the disclosure may be practiced are described in sufficient detail to enable those skilled in the art to practice the invention, and it is to be understood that other embodiments may be utilized and that logical, architectural, programmatic, mechanical, electrical, and other changes may be made without departing from the spirit or scope of the present disclosure. The following detailed description is, therefore, not to be taken in a limiting sense, and the scope of the present disclosure is defined by the appended claims and equivalents thereof. Within the descriptions of the different views of the figures, similar elements are provided similar names and reference numerals as those of the previous figure(s). The specific numerals assigned to the elements are provided solely to aid in the description and are not meant to imply any limitations (structural or functional or otherwise) on the described embodiment. It will be appreciated that for simplicity and clarity of illustration, elements illustrated in the figures have not necessarily been drawn to scale. For example, the dimensions of some of the elements are exaggerated relative to other elements.

It is understood that the use of specific component, device and/or parameter names, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that term is utilized.

As further described below, implementation of the functional features of the disclosure described herein is provided within processing devices and/or structures and can involve use of a combination of hardware, firmware, as well as several software-level constructs (e.g., program code and/or program instructions and/or pseudo-code) that execute to provide a specific utility for the device or a specific functional logic. The presented figures illustrate both hardware components and software and/or logic components.

Those of ordinary skill in the art will appreciate that the hardware components and basic configurations depicted in the figures may vary. The illustrative components are not intended to be exhaustive, but rather are representative to highlight essential components that are utilized to implement aspects of the described embodiments. For example, other devices/components may be used in addition to or in place of the hardware and/or firmware depicted. The depicted example is not meant to imply architectural or other limitations with respect to the presently described embodiments and/or the general invention. The description of the illustrative embodiments can be read in conjunction with the accompanying figures. Embodiments incorporating teachings of the present disclosure are shown and described with respect to the figures presented herein.

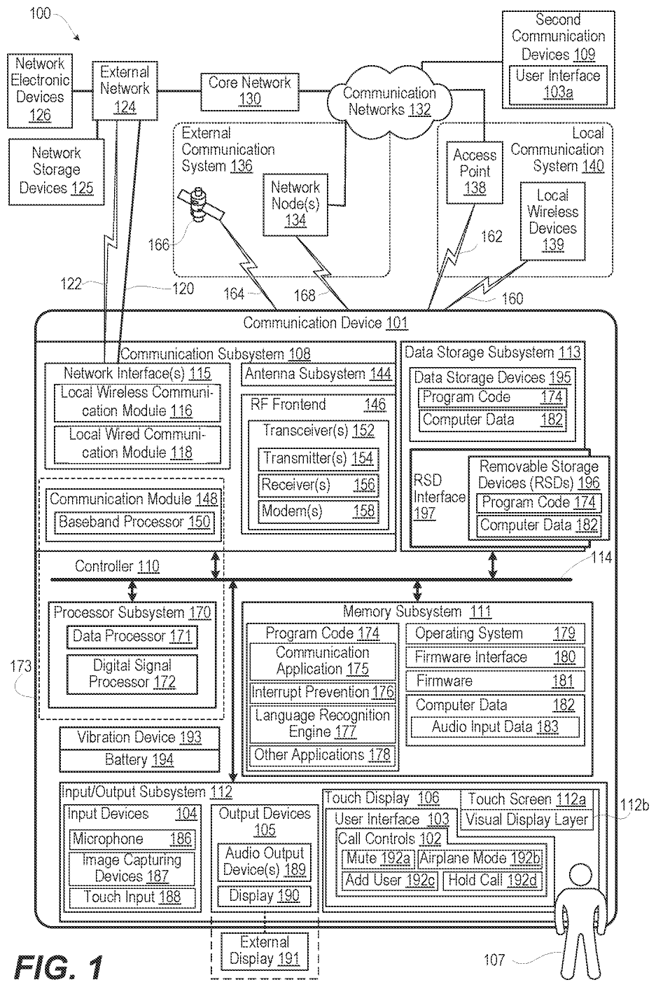

FIG. 1 is a functional block diagram of a communication environment 100 that includes a communication device in which the features of the present disclosure are advantageously implemented. In particular, communication device 101 has call controls 102, presented by user interface 103 via input/output (I/O) subsystem 104 that includes input devices 105a and output devices 105b. Some components may incorporate a combination of input devices 105a and output devices 105b such as touch display 106 having touch screen 112a on top of visual display layer 112b. that presents a visual portion of user interface 103. Touch screen 112a of touch display 106 receives user inputs made by user 107, for controlling an in-progress communication session, via communications subsystem 108 with one or more second communication devices 109. One or more of audio, visual, and textual inputs received by user interface 103 of communication device 101 may be transmitted to one or more second communication devices 109 for presenting at respective user interfaces 103a. Similarly, one or more of audio, visual, and textual inputs received respectively by user interfaces 103a of one or more second communication devices 109 may be transmitted to communication device 101 for presenting at user interface 103. Inadvertent input to call controls 102 may interrupt transmission to and/or reception from the communication session by communication device 101.

Communication device 101 can be one of a host of different types of devices, including but not limited to, a mobile cellular phone, satellite phone, or smart phone, a laptop, a netbook, an ultra-book, a networked smartwatch or networked sports/exercise watch, and/or a tablet computing device or similar device that can include wireless communication functionality. As a device supporting wireless communication, communication device 101 can be utilized as, and also be referred to as, a system, device, subscriber unit, subscriber station, mobile station (MS), mobile, mobile device, remote station, remote terminal, user terminal, terminal, user agent, user device, a

Session Initiation Protocol (SIP) phone, a wireless local loop (WLL) station, a personal digital assistant (PDA), computer workstation, a handheld device having wireless connection capability, a computing device, or other processing devices connected to a wireless modem.

Referring now to the specific component makeup and the associated functionality of the presented components. In addition to communications subsystem 108, communication device 101 includes controller 110 and memory subsystem 111, input/output (I/O) subsystem 112, and data storage subsystem 113. To enable management by controller 110, system interlink 114 communicatively connects controller 110 with communications subsystem 108, memory subsystem 111, input/output subsystem 112, and data storage subsystem 113. System interlink 114 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components. Although certain direct interconnections (i.e., system interlink 114) are illustrated in FIG. 1, it is to be understood that more, fewer, or different interconnections may be present in other embodiments.

In one or more embodiments, communications subsystem 108 may include one or more network interfaces 115, such as local wireless communication module 116 and local wired communication module 118, to communicatively couple communication device 101 via network cable 120 or wireless connection 122 to external networks 124. Communication device 101, via external networks 124, may connect to network storage devices 125 that store computer data and to network devices 126 such as network servers that facilitate access to network storage device 125. Communication device 101 may communicate with second communication devices 109 via external network 124 or via communication networks 132 that are supported by core networks 130. Network interface(s) 115 may include a network interface controller (NIC) and support one or more network communication protocols. External network 124 can be a local area network (LAN), a campus area network (CAN), a metropolitan area network (MAN), or a wide area network (WAN). For example, network cable 120 and wireless connection 122 can be an Ethernet connection/cable.

In one or more embodiments, communications subsystem 108 may include additional functionality for communicating, using a cellular connection, with network node(s) 134 of external communication system 136 and for communicating, using a wireless connection, with wireless access point 138 or local wireless devices 139 of local communication system 140. Communications subsystem 108 includes antenna subsystem 144. Communications subsystem 108 includes radio frequency (RF) front end 146 and communication module 148 having baseband processor 150. RF front end 146 includes transceiver(s) 152, which includes transmitter(s) 154 and receiver(s) 156. RF front end 146 further includes modem(s) 158. Baseband processor 150 of communication module 148 communicates with controller 110 and RF front end 146. Baseband processor 150 operates in a baseband frequency range to encode data for transmission and decode received data, according to a communication protocol. Modem(s) 158 modulates baseband encoded data from communication module 148 onto a carrier signal to provide a transmit signal that is amplified by transmitter(s) 154. Modem(s) 158 demodulates each signal received using antenna subsystem 144 from external communication system 136 or local communication system 140. The received signal is amplified and filtered by receiver(s) 156, which demodulates received encoded data from a received carrier signal.

In one or more embodiments, controller 110, via communications subsystem 108, performs multiple types of cellular over-the-air (OTA) or wireless communication with local communication system 140. Communications subsystem 108 can communicate via an OTA connection 160 with local wireless devices 139. In an example, OTA connection 160 is a Bluetooth connection, or other personal access network (PAN) connection. In one or more embodiments, communications subsystem 108 communicates with one or more locally networked devices via a wireless local area network (WLAN) link 162 supported by access point 138. In one or more embodiments, access point 138 supports communication using one or more IEEE 802.11 WLAN protocols. Access point 138 is connected to communication networks 132 via a cellular or wired connection. In one or more embodiments, communications subsystem 108 receives downlink channels 164 from GPS satellites 166 to obtain geospatial location information. Communications subsystem 108 can communicate via an over-the-air (OTA) cellular connection 168 with network node(s) 134.

Controller 110 includes processor subsystem 170, which includes one or more central processing units (CPUs), depicted as data processor 171. Processor subsystem 170 can include one or more digital signal processors 172 that can be integrated with data processor 171. Processor subsystem 170 can include other processors that are communicatively coupled to data processor 171, such as baseband processors 150 of communication module 148. In one or more embodiments that are not depicted, controller 110 can further include distributed processing and control components that are external to housing 173 or grouped with other components, such as I/O subsystem 104. Data processor 171 is communicatively coupled, via system interlink 114, to memory subsystem 111. In one or more embodiments, data processor 171 is communicatively coupled via system interlink 114 to I/O subsystem 104, communications subsystem 108, and data storage subsystem 113. Controller 110 manages, and in some instances directly controls, the various functions and/or operations of communication device 101. These functions and/or operations include, but are not limited to including, application data processing, communication with second communication devices, navigation tasks, image processing, and signal processing. In one or more alternate embodiments, communication device 101 may use hardware component equivalents for application data processing and signal processing. For example, communication device 101 may use special purpose hardware, dedicated processors, general purpose computers, microprocessor-based computers, micro-controllers, optical computers, analog computers, dedicated processors and/or dedicated hard-wired logic.

Memory subsystem 111 stores program code 174 for execution/processing by processor subsystem 170 to provide the various functionalities described herein. Program code 174 includes applications such as communication application 175, communication interruption prevent (CIP) application 176, language recognition engine (LRE) application 177, and other applications 178. In one or more embodiments, several of the described aspects of the present disclosure are provided via executable program code of applications executed by controller 110. In one or more embodiments, program code 174 may be integrated into a distinct chipset or hardware module as firmware that operates separately from executable program code. Portions of program code 174 may be incorporated into different hardware components that operate in a distributed or collaborative manner. Implementation of program code 174 may use any known mechanism or process for doing so using integrated hardware and/or software, as known by those skilled in the art.

Memory subsystem 111 further includes operating system (OS) 179, firmware interface 180, such as basic input/output system (BIOS) or Uniform Extensible Firmware Interface (UEFI), and firmware 181. Memory subsystem 111 includes computer data 182 such audio input data 183 analyzed by LRE application 177. Computer data 182 may incorporate “data” that originated as raw, real-world “analog” information that consists of basic facts and figures. Computer data 182 includes different forms of data, such as numerical data, images, coding, notes, and financial data. The computer data may originate at communication device 101 or be retrieved by communication device 101. Communication device 101 may store, modify, present, or transmit computer data 182. Computer data may be organized in one of a number of different data structures. Common examples of computer data 182 include video, graphics, text, and images as discussed herein. Computer data 182 can also be in other forms of flat files, databases, and other data structures.

Input devices 105a of I/O subsystem 104 may include microphone 186, image capturing devices 187, and mechanical input devices 188 (e.g., keys and buttons). Output devices 105b of I/O subsystem 104 may include audio output devices 189, haptic output devices 190 and/or external display 191. Touch display 106 of I/O subsystem 104 may present, via user interface 103, call controls 102 such as mute control 192a, airplane mode control 192b, add user control 192c, and hold call control 192d. I/O subsystem 104 may include haptic or tactile output devices, such as vibration device 193 that oscillates a mass such as battery 194 to create vibratory alerts.

Data storage subsystem 113 of communication device 101 includes data storage device(s) 195. Controller 110 is communicatively connected, via system interlink 114, to data storage device(s) 195. Data storage subsystem 113 provides program code 174 and computer data 182 stored on nonvolatile storage that is accessible by controller 110. For example, data storage subsystem 113 can provide a selection of computer data 182 and applications, such as communication application 175 and other application(s) 178. These applications can be loaded into memory subsystem 111 for execution by controller 110. In one or more embodiments, data storage device(s) 195 can include hard disk drives (HDDs), optical disk drives, and/or solid-state drives (SSDs), etc. Data storage subsystem 113 of communication device 101 can include removable storage device(s) (RSD(s)) 196, which is received in RSD interface 197. Controller 110 is communicatively connected to RSD 196, via system interlink 114 and RSD interface 197. In one or more embodiments, RSD 196 is a non-transitory computer program product or computer readable storage device. Controller 110 can access data storage device(s) 195 or RSD 196 to provision communication device 101 with program code, such as program code for communication application 175, screen shot application 177, and other application(s) 178, and with computer data 182 such as default call control settings.

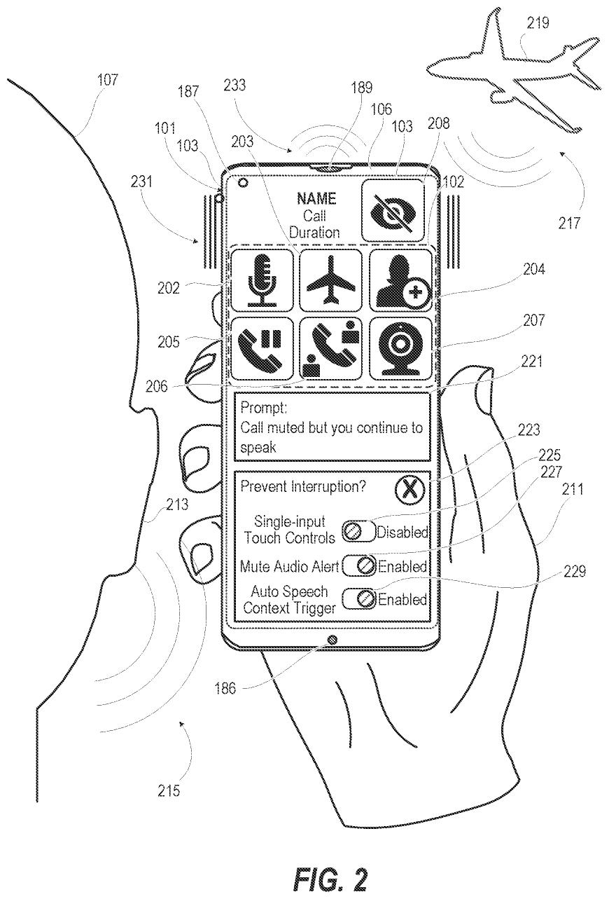

FIG. 2 depicts a front view of communication device 101 having user interface 103 presenting call controls 102 whose inadvertent selection may interrupt outgoing communication during a communication session. In an example, calls controls 102 are presented as the following soft toggle buttons: mute control 202, airplane mode control 203, add user control 204, hold call control 205, disconnect call control 206, and camera on/off control 207. According to aspects of the present disclosure, a soft toggle button for hide control 208 may be presented. The hide control 208 may be automatically presented and/or automatically selected in certain contexts to prevent a single inadvertent touch that at least partially interrupts the communication session. Selection of hide control 208 converts call controls 102 from single-action input to multiple-action input. In order to select one of call controls 102 after hide control 208 has been selected requires first toggling hide control 208 again. The depiction of hide control 208 may toggle between a hide or show icon to indicate status. Call controls 102 affected by hide control 208 may disappear or be grayed out, corresponding to whether hide control 208 is activated or inactive. In one or more embodiments, hide control 208 is a default selection at the beginning of a call session or is manually selected or de-selected by user input.

Communication device 101 presents input devices 105a (FIG. 1) such as microphone 186 and image capturing device 187 toward user 107. Communication device 101 also presents output devices 105 (FIG. 1) such as audio output device 189 toward user 107 when communication device 101 is held by hand 211 of user 107 up to ear 213. Microphone 186 captures an audio input that includes spoken speech 215 by user 107 and may include background noise 217 from noise sources such as a passing vehicle 219. This use as a traditional telephone handset creates situations where inadvertent touching of input controls within user interface 103 presented by touch display 106 can occur. Inadvertent inputs may happen due to the way that the communication device 101 is being held or due to the screen of communication device 101 being brought into contact with another external object, such as a body part of the user while not being held (e.g., in a pocket or on a desk).

According to aspects of the present disclosure communication device 101 generates one or more prompts via output devices 105 (FIG. 1) indicating that a user input that turns off transmission to the communication session of at least the received audio input by microphone 186 has been activated. The prompts are generated in response to determining a high probability that subsequent speech (detected by the microphone in soft-muted status) is intended for the communication session, which further indicates/implies that the user input was inadvertent. As an example, visual prompt 221 can be presented on touch display 106. In another example, vibration device 193 (FIG. 1) activates to create a vibration prompt 231, which may be more effective than visual prompt 221 when user 107 is not looking at touch display 106. In an additional example, audio output device 189 may generate an audio prompt 233, such as a tone or word to alert user 107. Audio and vibration prompts 231 and 233 may direct user 107 to view touch display 106 for additional information and to take corrective action, as/if needed.

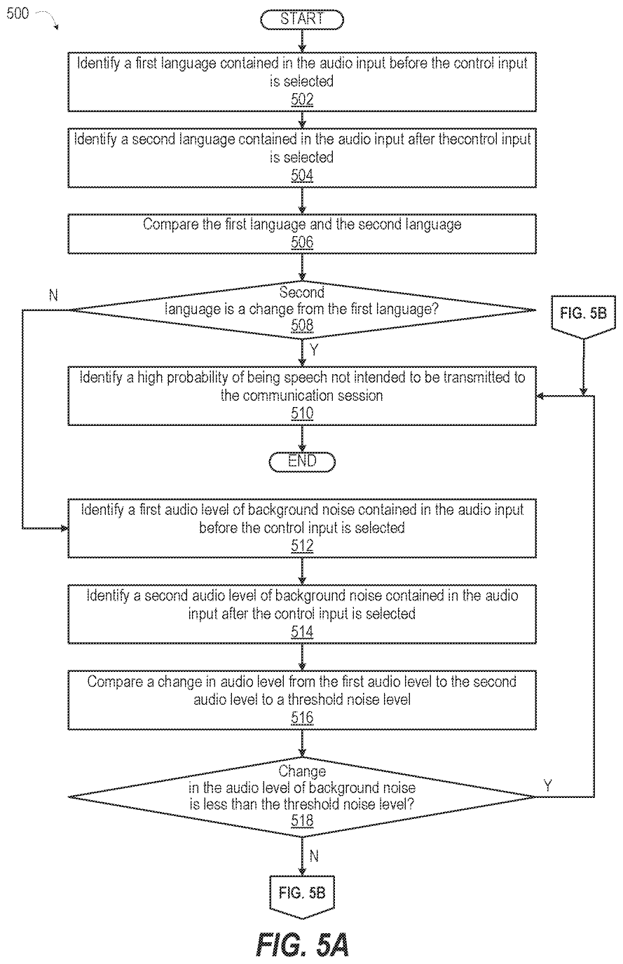

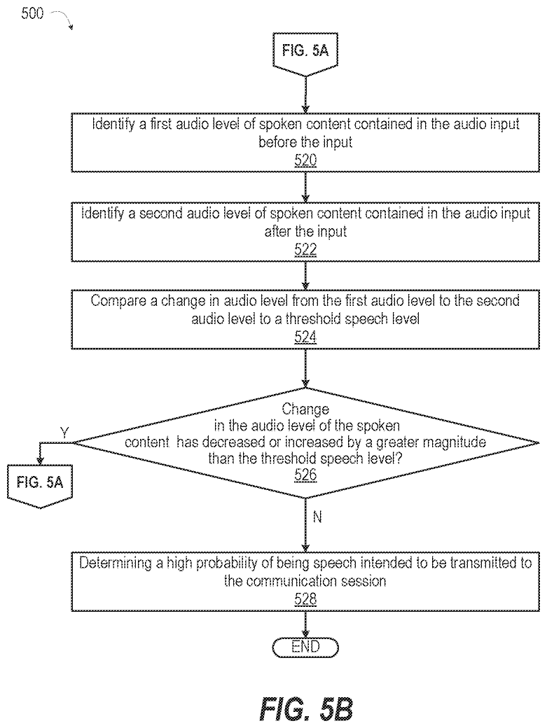

In an additional example, communication device 101 may present call control settings 223 on touch display 106, enabling user 107 to change operation of user interface 103, thus preventing future inadvertent inputs. Call control settings 223 may include single-action enable/disable control 225 that governs use and operation of hide control 208. In an example, enabling single-action enable/disable control 225 may cause hide control 208 to be presented. In another example, enabling single-action enable/disable control 225 may cause hide control 208 to automatically default to the active state, requiring multiple-action input to select call controls 102. Call control settings 223 may include nonvisual alert enable/disable control 227 to govern use of audio and vibration prompts 231 and 233. Call control settings 223 may include auto speech context trigger enable/disable control 229 that govern whether certain speech characteristics are monitored for determining a high-probability that subsequent speech is intended for the on-going communication session. Examples of such speech monitoring are described in method 500 (FIGS. 5A-5B).

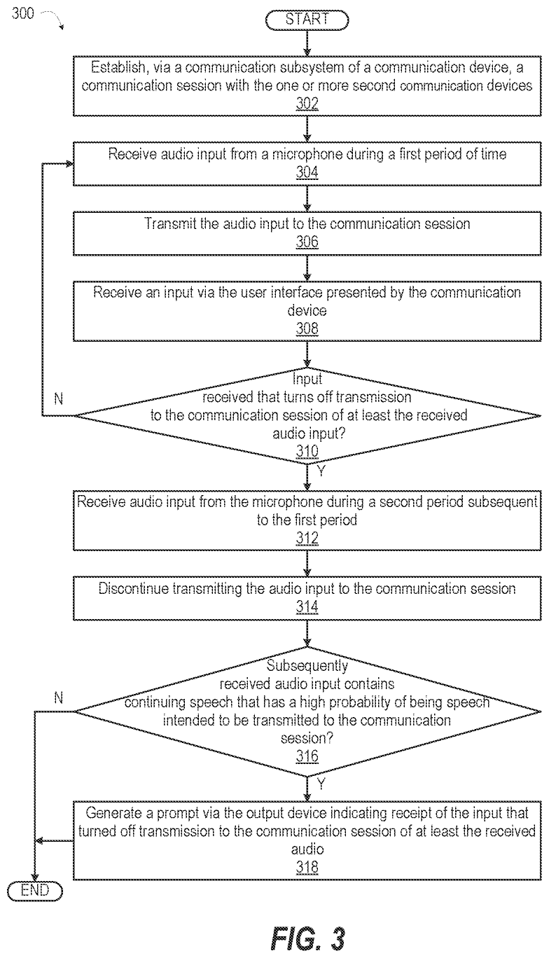

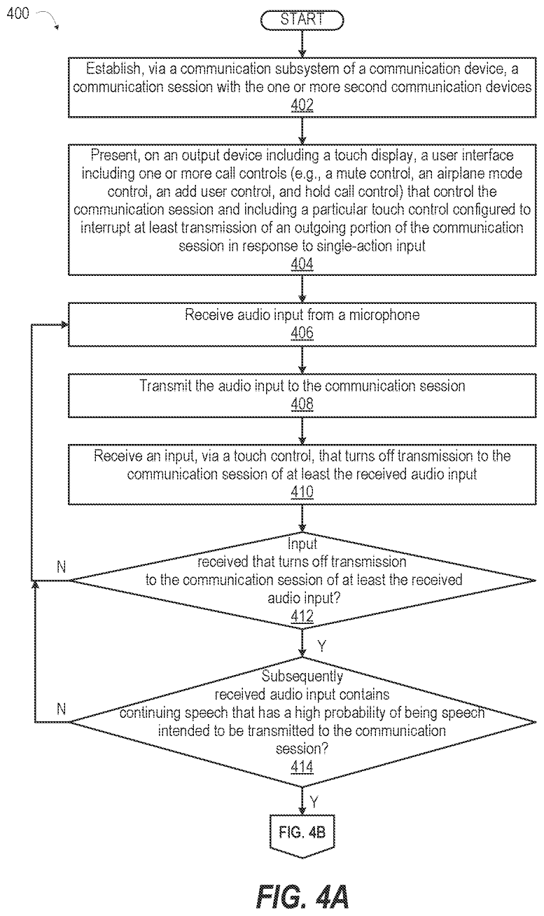

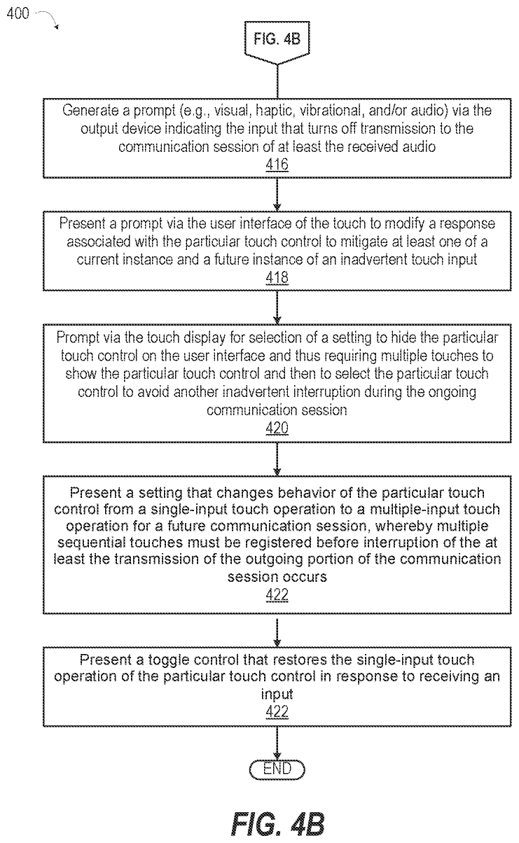

FIG. 3 is a flow diagram presenting an example method of mitigating inadvertent user inputs to call controls of a communication device, for inadvertent inputs that interrupt outgoing communication during a communication session. FIGS. 4A-4B (collectively “FIG. 4”) are a flow diagram presenting method 400, which is an implementation of method 300 (FIG. 3), but implemented on a communication device having a touch display. FIGS. 5A-5B (collectively “FIG. 5”) are a flow diagram presenting method 500 of example implementations for method 300 (FIG. 3) of determining that subsequent speech, after an input that interrupts the outgoing communication, has a high probability of being intended for the communication session. The descriptions of method 300 (FIG. 3), method 400 (FIG. 4), and method 500 (FIG. 5) are provided with general reference to the specific components illustrated within the preceding FIGS. 1 and 2. Specific components referenced in method 300 (FIG. 3), method 400 (FIG. 4), method 500 (FIG. 5) may be identical or similar to components of the same name used in describing preceding FIGS. 1 and 2. In one or more embodiments, controller 110 (FIG. 1) configures communication device 101 (FIGS. 1 and 2) to provide the described functionality of method 300 (FIG. 3), method 400 (FIG. 4), method 500 (FIG. 5).

With reference to FIG. 3, method 300 includes establishing, via a communications subsystem of a communication device, a communication session with the one or more second communication devices (block 302). Method 300 includes receiving audio input from a microphone during a first period of time (block 304) and transmitting the audio input to the communication session (block 306). Method 300 includes receiving an input via a user interface presented by the communication device (block 308). Method 300 includes determining whether the received input turns off transmission to the communication session of at least the received audio input (decision block 310). In response to determining that the input does not turn off transmission to the communication session of at least the received audio input, method 300 returns to block 304. In response to determining that the input turns off transmission to the communication session of at least the received audio input, method 300 includes receiving audio input from the microphone during a second period of time subsequent to the first period (block 312). Method 300 includes discontinuing transmitting the audio input to the communication session (block 314). Method 300 includes determining whether subsequently received audio input during the second period contains continuing speech that has a high probability of being speech intended to be transmitted to the communication session (decision block 316). Examples of implementations of block 316 are provided below as method 500 (FIG. 5). With continued reference to FIG. 3, in response to determining that subsequently received audio input does not contain continuing speech that has a high probability of being speech intended to be transmitted to the communication session, method 300 ends. In response to determining that subsequently received audio input contains continuing speech that has a high probability of being speech intended to be transmitted to the communication session, method 300 includes generating a prompt via the output device indicating receipt of the input that turned off transmission to the communication session of at least the received audio input (block 318). Then method 300 ends.

With reference to FIG. 4A, method 400 includes establishing, via a communications subsystem of a communication device, a communication session with the one or more second communication devices (block 402). Method 400 includes presenting, on an output device including a touch display, a user interface including one or more call controls (e.g., a mute control, an airplane mode control, an add user control, and hold call control) that control the communication session and including a particular touch control configured to interrupt at least transmission of an outgoing portion of the communication session in response to single-action input (block 404). Method 400 includes receiving audio input from a microphone (block 406) and transmitting the audio input to the communication session (block 408). Method 400 includes receiving an input, via a touch control, (block 410). Method 400 includes determining whether the input turns off transmission to the communication session of at least the received audio input (decision block 412). In response to determining that the input does not turn off transmission to the communication session of at least the received audio input, method 400 returns to block 406. In response to determining that the input turns off transmission to the communication session of at least the received audio input, method 400 includes determining whether subsequently received audio input contains continuing speech that has a high probability of being speech intended to be transmitted to the communication session (block 414). In response to determining that subsequently received audio input does not contain continuing speech that has a high probability of being speech intended to be transmitted to the communication session, method 400 returns to block 406. In response to determining that subsequently received audio input contains continuing speech that has a high probability of being speech intended to be transmitted to the communication session, method 400 proceeds to block 416 of FIG. 4B.

With reference to FIG. 4B, method 400 includes generating a prompt (e.g., visual, haptic, vibrational, and/or audio) via the output device indicating activation the input that turns off transmission to the communication session of at least the received audio input (block 416). In one or more embodiments, method 400 includes presenting a prompt via a user interface of the touch to modify a response associated with the particular touch control to mitigate at least one of a current instance and a future instance of an inadvertent touch input (block 418). The prompt enables the user to undo the input and re-enable transmission of the received audio to the communication session. In an example, the user is able to modify, via the user interface, a response associated with the particular touch control that toggles between transmitting and not transmitting audio input.

In one or more embodiments, method 400 includes prompting via the touch display for selection of a setting to hide the particular touch control on the user interface and thus requiring multiple touches to show the particular touch control and then to select the particular touch control to avoid another inadvertent interruption during the ongoing communication session (block 420).

In one or more embodiments, method 400 includes prompting via the touch display includes presenting a setting that changes behavior of the particular touch control from a single-input touch operation to a multiple-input touch operation for a future communication session, whereby multiple sequential touches must be registered before interruption of the at least the transmission of the outgoing portion of the communication session occurs (block 422).

In one or more particular embodiments, prompting via the touch display includes presenting a toggle control that restores the single-input touch operation of the particular touch control in response to receiving an input (block 424). In an example, the user may switch a manner of holding the electronic device, such as placing on a table, and wish to restore single touch operation. Then method 400 ends.

With reference to FIG. 5A, method 500 includes identifying a first language contained in the audio input before the control input is selected (block 502). Method 500 includes identifying a second language contained in the audio input after the control input is selected (block 504).

Method 500 includes comparing the first language and the second language (block 506). Method 500 includes determining whether the second language is a change from the first language (decision block 508). In response to determining that the second language is a change from the first language, method 500 includes identifying the high probability of being speech not intended to be transmitted to the communication session (block 510). Then method 500 ends.

In response to determining that the second language is not a change from the first language in decision block 508, method 500 includes identifying a first audio level of background noise contained in the audio input before the control input is selected (block 512). Method 500 includes identifying a second audio level of background noise contained in the audio input after the control input is selected (block 514). Method 500 includes comparing a change in audio level from the first audio level to the second audio level to a threshold noise level (block 516). Method 500 includes determining whether the change in the audio level of the background noise is less than the threshold noise level (decision block 518). In response to determining that the change in the audio level of the background noise is less than the threshold noise level, method 500 returns to block 510. In response to determining that the change in the audio level of the background noise is greater than or equal to the threshold noise level, method 500 proceeds to block 520 of FIG. 5B.

With reference to FIG. 5B, method 500 includes identifying a first audio level of spoken content contained in the audio input before the control input is selected (block 520). Method 500 includes identifying a second audio level of spoken content contained in the audio input after the control input is selected (block 522). Method 500 includes comparing a change in audio level from the first audio level to the second audio level to a threshold speech level (block 524). Method 500 includes determining whether the change in the audio level of the spoken content has decreased or increased by a greater magnitude than the threshold speech level (decision block 526). In response to determining that the change in the audio level of the spoken content has decreased or increased by a greater magnitude than the threshold speech level, method 500 returns to block 510 (FIG. 5A). In response to determining that the change in the audio level of the spoken content has not decreased or increased by a greater magnitude than the threshold speech level, method 500 includes determining that there is a high probability of the speech being speech intended to be transmitted to the communication session (block 528). Then, method 500 ends.

Aspects of the present innovation are described above with reference to flowchart illustrations and/or block diagrams of methods, apparatus (systems) and computer program products according to embodiments of the innovation. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

As will be appreciated by one skilled in the art, embodiments of the present innovation may be embodied as a system, device, and/or method. Accordingly, embodiments of the present innovation may take the form of an entirely hardware embodiment or an embodiment combining software and hardware embodiments that may all generally be referred to herein as a “circuit,”“module” or “system.”

While the innovation has been described with reference to exemplary embodiments, it will be understood by those skilled in the art that various changes may be made, and equivalents may be substituted for elements thereof without departing from the scope of the innovation. In addition, many modifications may be made to adapt a particular system, device, or component thereof to the teachings of the innovation without departing from the essential scope thereof. Therefore, it is intended that the innovation not be limited to the particular embodiments disclosed for carrying out this innovation, but that the innovation will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the innovation. As used herein, the singular forms “a”, “an” and “the” are intended to include the plural forms as well, unless the context clearly indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present innovation has been presented for purposes of illustration and description but is not intended to be exhaustive or limited to the innovation in the form disclosed. Many modifications and variations will be apparent to those of ordinary skill in the art without departing from the scope and spirit of the innovation. The embodiments were chosen and described in order to best explain the principles of the innovation and the practical application, and to enable others of ordinary skill in the art to understand the innovation for various embodiments with various modifications as are suited to the particular use contemplated.

What is claimed is:

1. A communication device comprising:
a communications subsystem that enables the communication device to communicatively connect to one or more second communication devices;
a microphone;
an output device; and
a controller communicatively connected to the communications subsystem, the microphone, and the output device, and which:
establishes, via the communications subsystem, a communication session with the one or more second communication devices;
receives audio input from the microphone;
transmits the audio input to the communication session;
receives an input that turns off transmission to the communication session of at least the received audio input;
in response to receiving the input that turns off transmission to the communication session of at least the received audio input, determines whether subsequently received audio input contains continuing speech that has a high probability of being speech intended to be transmitted to the communication session; and
generates a prompt via the output device indicating the input that turns off transmission to the communication session of at least the received audio input has been activated.

2. The communication device of claim 1, wherein:
the output device comprises a touch display; and
the controller:
presents, on the touch display, a user interface comprising one or more call controls that control the communication session and comprising a particular touch control configured to interrupt at least transmission of an outgoing portion of the communication session in response to single-action input;
receives the input via the particular touch control that turns off transmission to the communication session of at least the received audio input; and
in response to receiving the input that turns off transmission to the communication session of at least the received audio input, determines whether subsequently received audio input contains continuing speech that has a high probability of being speech intended to be transmitted to the communication session indicating an inadvertent touch input.

3. The communication device of claim 2, wherein the controller generates the prompt for the user to undo the input and re-enable transmission of the received audio to the communication session. via the user interface to modify a response associated with the particular touch control to mitigate at least one of a current instance and a future instance of an inadvertent touch input.

4. The communication device of claim 2, wherein the particular touch control is a call control from a group comprising: (i) a mute control; (ii) an airplane mode control; (iii) an add user control; and (iv) hold call control.

5. The communication device of claim 2, wherein the controller prompts for selection of a setting to hide the particular touch control on the user interface.

6. The communication device of claim 2, wherein the controller generates the prompt comprising a setting that changes behavior of the particular touch control from a single-input touch operation to a multiple-input touch operation before interrupting the at least the transmission of the outgoing portion of the communication session.

7. The communication device of claim 6, wherein the controller presents a toggle control that restores the single-input touch operation of the particular touch control in response to receiving an input.

8. The communication device of claim 1, wherein the controller:
identifies a language contained in the audio input; and
identifies a high probability of being speech not intended to be transmitted to the communication session based at least in part on a change from a first language to a second language.

9. The communication device of claim 1, wherein the controller:
identifies an audio level of background noise contained in the audio input; and
determines the high probability of being speech intended to be transmitted to the communication session based, at least in part, on an increase in the audio level of the background noise above a threshold noise level.

10. The communication device of claim 1, wherein the controller:
identifies an audio level of spoken content contained in the audio input; and
determines a high probability of being speech not intended to be transmitted to the communication session based, at least in part, on a decrease in the audio level of the spoken content below a threshold speech level.

11. A method comprising:
establishing, via a communications subsystem of a communication device, a communication session with one or more second communication devices;
receiving audio input from a microphone;
transmitting the audio input to the communication session;
receiving an input that turns off transmission to the communication session of at least the received audio input;
in response to receiving the input that turns off transmission to the communication session of at least the received audio input, determining whether subsequently received audio input contains continuing speech that has a high probability of being speech intended to be transmitted to the communication session; and
generating a prompt via an output device indicating the input that turns off transmission to the communication session of at least the received audio input.

12. The method of claim 11, further comprising:
presenting, on the output device comprising a touch display, a user interface comprising one or more call controls that control the communication session and comprising a particular touch control configured to interrupt at least transmission of an outgoing portion of the communication session in response to single-action input;
receiving the input via the particular touch control that turns off transmission to the communication session of at least the received audio input;
in response to receiving the input that turns off transmission to the communication session of at least the received audio input, determining whether subsequently received audio input contains continuing speech that has a high probability of being speech intended to be transmitted to the communication session indicating an inadvertent touch input; and
generating the prompt for the user to undo the input and re-enable transmission of the received audio to the communication session. via the user interface to modify a response associated with the particular touch control to mitigate at least one of a current instance and a future instance of an inadvertent touch input, wherein the particular touch control is a call control from a group comprising: (i) a mute control; (ii) an airplane mode control; (iii) an add user control; and (iv) hold call control.

13. The method of claim 12, further comprising prompting via the touch display for selection of a setting to hide the particular touch control on the user interface.

14. The method of claim 12, further comprising prompting via the touch display by presenting a setting that changes behavior of the particular touch control from a single-input touch operation to a multiple-input touch operation before interrupting the at least the transmission of the outgoing portion of the communication session.

15. The method of claim 14, wherein prompting via the touch display comprise presenting a toggle control that restores the single-input touch operation of the particular touch control in response to receiving an input.

16. The method of claim 11, further comprising:
identifying a language contained in the audio input; and
identifying a high probability of being speech not intended to be transmitted to the communication session based at least in part on a change from a first language to a second language.

17. The method of claim 11, further comprising:
identifying an audio level of background noise contained in the audio input; and
determining the high probability of being speech intended to be transmitted to the communication session based, at least in part, on an increase in the audio level of the background noise above a threshold noise level.

18. The method of claim 11, further comprising:
identifying an audio level of spoken content contained in the audio input; and
determining a high probability of being speech not intended to be transmitted to the communication session based, at least in part, on a decrease in the audio level of the spoken content below a threshold speech level.

19. A computer program product comprising:
a computer readable storage device; and
program code on the computer readable storage device that when executed by a processor associated with a communication device, the program code enables the communication device to provide functionality of:
establishing, via a communications subsystem of the communication device, a communication session with one or more second communication devices;
receiving audio input from a microphone;
transmitting the audio input to the communication session;
receiving an input that turns off transmission to the communication session of at least the received audio input;
in response to receiving the input that turns off transmission to the communication session of at least the received audio input, determining whether subsequently received audio input contains continuing speech that has a high probability of being speech intended to be transmitted to the communication session; and
generating a prompt via an output device indicating the input that turns off transmission to the communication session of at least the received audio input.

20. The computer program product of claim 19, wherein the program code enables the communication device to provide functionality of
presenting, on the output device comprising touch display, a user interface comprising one or more call controls that control the communication session and comprising a particular touch control configured to interrupt at least transmission of an outgoing portion of the communication session in response to single-action input;
receiving the input via the particular touch control that turns off transmission to the communication session of at least the received audio input;
in response to receiving the input that turns off transmission to the communication session of at least the received audio input, determining whether subsequently received audio input contains continuing speech that has a high probability of being speech intended to be transmitted to the communication session indicating an inadvertent touch input; and
generating the prompt for the user to undo the input and re-enable transmission of the received audio to the communication session. via the user interface to modify a response associated with the particular touch control to mitigate at least one of a current instance and a future instance of an inadvertent touch input, wherein the particular touch control is a call control from a group comprising: (i) a mute control; (ii) an airplane mode control; (iii) an add user control; and (iv) hold call control.
